(19) United States
(12) Patent Application Publication
(10) Pub. No.: US 2026/0178484 A1
(43) Pub. Date: Jun. 25, 2026

(54) MULTI-BACKEND DISAGGREGATED MEMORY SYSTEM AND ITS OPTIMIZED CONTROL METHOD

(71) Applicant: SHANGHAI JIAO TONG UNIVERSITY, Shanghai (CN)

(72) Inventors: Chao LI, Shanghai (CN); Jing WANG, Shanghai (CN); Hanzhang YANG, Shanghai (CN); Xiaofeng HOU, Shanghai (CN); Minyi GUO, Shanghai (CN)

(73) Assignee: SHANGHAI JIAO TONG UNIVERSITY, Shanghai (CN)

(21) Appl. No.: 19/536,480

(22) Filed: Feb. 11, 2026

Related U.S. Application Data
(63) Continuation of application No. PCT/CN2025/127166, filed on Oct. 12, 2025.

(30) Foreign Application Priority Data
Oct. 18, 2024 (CN) 202411458241.0

(51) Int. Cl. G06F 12/02; G06F 3/06; G06F 12/1009

(52) U.S. Cl. CPC G06F 12/0246; G06F 3/0659; G06F 12/1009

(57) ABSTRACT

A multi-backend disaggregated memory system and its optimized control method, comprising: an intelligent multi-backend disaggregated memory management and control module and a data swapper of multi-backend disaggregated memory, and wherein: the intelligent multi-backend disaggregated memory management and control module analyzes and processes calls that cause page faults and trigger page swapping, to obtain switch instruction information and parameter regulation instruction information; the data swapper of multi-backend disaggregated memory receives the switch instruction information and parameter adjustment instruction information, adjust system parameters configuration, runs applications on the multi-backend disaggregated memory software system, and releases resources after the execution ends. By supporting the memory swap strategy and system architecture of multiple heterogeneous disaggregated memory backends, the present invention realizes parallel access of multiple far memory paths to improve data throughput, and at the same time analyzes application characteristics to implement intelligent backend switching and data swap parameter adjustment.

### CROSS-REFERENCE TO RELATED APPLICATIONS

This application is the U.S. continuation of application of International Application No. PCT/CN2025/127166 filed on 12 Oct. 2025 which designated the U.S. and claims priority to Chinese Application No. CN202411458241.0 filed on 18 Oct. 2024, the entire contents of each of which are hereby incorporated by reference.

### TECHNICAL FIELD

The present invention relates to a technology in the field of optimal allocation of computing resources, specifically a multi-backend disaggregated memory system and its optimized control method.

### BACKGROUND TECHNOLOGY

With the rapid growth of data volume processed by applications, the memory resource occupation of applications is increasing, and memory resources in traditional data centers are very tight. To alleviate the pressure on memory resources, the disaggregated and composable architecture has been proposed in recent years, allowing tasks on computing nodes to flexibly access disaggregated memory resources of heterogeneous memory nodes or fast storage devices, also known as “far memory” resources. People usually use the way of data swap between local memory and far memory to offload data to the far memory space and load it back to the local memory on demand. However, existing far memory systems are still not efficient enough. On the one hand, the existing far memory access architecture only supports data swap between local memory and a single far memory backend, does not support multiple memory swap backend devices, and does not support multiple far memory access paths, resulting in low data throughput and lack of parallelism. On the other hand, existing far memory systems do not support intelligent control and management methods for far memory access paths, cannot give full play to the performance advantages of heterogeneous far memory devices, and lack dynamic regulation and management strategies.

### SUMMARY OF THE INVENTION

Aiming at the data throughput problem caused by the existing technology not supporting multiple far memory access paths and the system efficiency problem caused by not supporting dynamic regulation and control of multi-path far memory access, the present invention proposes a multi-backend disaggregated memory system and its optimized control method. By supporting the memory swap strategy and system architecture of multiple heterogeneous disaggregated memory backends, the present invention realizes parallel access of multiple far memory paths to improve data throughput, and at the same time analyzes application characteristics to implement intelligent backend switching and data swap parameter adjustment. It can achieve parallel access of multiple memory swap backend devices, fine-grained parameter configuration of far memory access paths, real-time switching of multiple memory swap backends, and an intelligent control and management method for far memory access paths.

The present invention is realized through the following technical solutions:

The present invention relates to a multi-backend disaggregated memory system, comprising: an intelligent multi-backend disaggregated memory management and control module and a data swapper of multi-backend disaggregated memory, and wherein: the far memory intelligent multi-backend disaggregated memory management and control module analyzes and processes calls that cause page faults and trigger page swapping, to obtain switch instruction information and parameter regulation instruction information; the data swapper of multi-backend disaggregated memory receives and executes the switch instruction information and parameter regulation instruction information, runs applications on the disaggregated memory architecture and multi-backend far memory software system, and releases resources after the operation ends.

The disaggregated memory refers to: physically remote memory or virtualized external memory for computing units. Tasks run on processing units on servers (as Compute Nodes) as accessing far memory devices on memory nodes through buses or networks across servers.

The multi-backend disaggregated memory system refers to: on the basis of using local memory of computing nodes, there are multiple heterogeneous additional virtual or physical memory nodes. The system can allow applications to perform memory access to these additional memory spaces, including but not limited to access to far memory spaces based on RDMA networks, access based on local additional memory devices, and access based on local fast storage devices.

### Technical Effects

The present invention solves the limitation that existing far memory systems only support a single memory swap backend, increases memory swap paths, improves data parallelism, reduces the overhead of far memory backend switching, and optimizes the performance of far memory data swap. By triggering more memory data offloading, the number of running tasks is increased, thus the overall task throughput is improved, and the overall memory resource utilization rate of the data center is also improved.

Compared with the prior art, the present invention can allocate the optimal memory swap backend according to application characteristics, configure high-performance far memory access parameters for it, and provide transparent use for applications. It supports mutual isolation of memory backends between different applications, enabling parallel execution without mutual interference.

### BRIEF DESCRIPTION OF THE DRAWINGS

FIG. 1 is a schematic diagram of the system of the present invention;

FIG. 2 is a flow chart of the present invention;

FIG. 3 is a schematic diagram of the switching decision flow of the far memory data swap backend of the present invention;

FIG. 4 is a schematic diagram of the flow of offline analysis of application lifecycle access characteristics and online regulation of multi-dimensional parameters of far memory swap paths in the present invention;

FIG. 5 is a schematic diagram of the structure of the data swapper of multi-backend disaggregated memory;

FIG. 6 is an execution flow chart of lightweight memory backend switching based on the warm start principle;

FIG. 7 is a schematic diagram of the implementation scenario of this embodiment;

FIG. 8 is a comparison diagram of far memory backend switching time;

FIG. 9 is a diagram of the results of the overall task throughput improved by the embodiment.

### DETAILED DESCRIPTION OF THE INVENTION

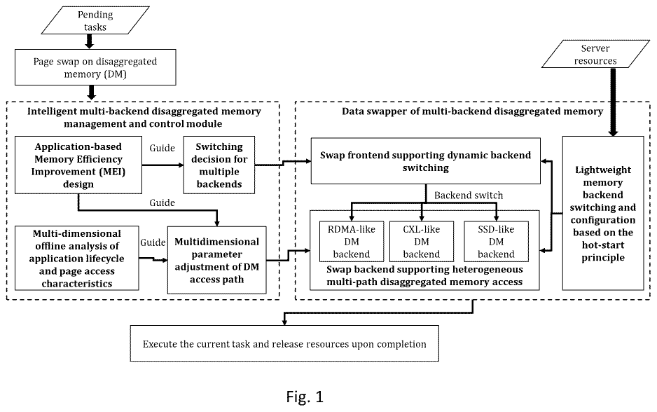

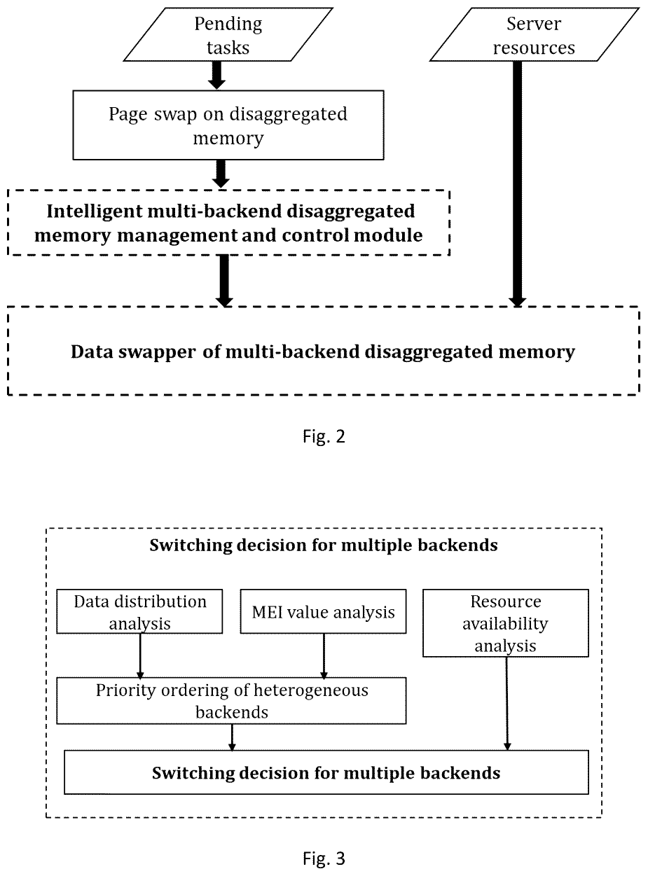

As shown in FIGS. 1 and 2, a multi-backend disaggregated memory system involved in this embodiment includes: an intelligent multi-backend disaggregated memory management and control module and a data swapper of multi-backend disaggregated memory, and wherein: the intelligent multi-backend disaggregated memory management and control module analyzes and processes calls that cause page faults and trigger page swapping. The memory efficiency improvement value recording module based on far memory swap path operation data records the MEI value of the application and performs multi-dimensional offline analysis on the application's lifecycle and page access characteristics, to obtain instruction information for switching the far memory data swap backend and instruction information for multi-dimensional parameter regulation of the far memory swap path. Subsequently, the data swapper of multi-backend disaggregated memory receives and executes the switch instruction information and parameter regulation instruction information, and connects to various ready far memory backends supporting heterogeneous multi-paths, including RDMA-like far memory backends, CXL-like far memory backends, and disk-like far memory backends, and implements specific backend switching according to the instruction information of the far memory intelligent multi-backend disaggregated memory management and control module; then, based on the lightweight memory switching configuration strategy of the warm start principle, it analyzes the current resource usage and task deployment status of the current server, and preferentially deploys tasks to the already configured processing units, finally completing the operation of the application on the disaggregated memory architecture and multi-backend far memory software system.

The far memory intelligent multi-backend disaggregated memory management and control module comprises: a Memory Efficiency Improvement (MEI) value recording unit based on far memory swap path operation data, a switching strategy decision unit for far memory data swap backends, a regulation unit for far memory swap path parameters, and a multi-dimensional offline analysis unit for application lifecycle and page access characteristics, and wherein: while the MEI value recording unit records the MEI value of the application and transmits it to the switching strategy decision unit and the regulation unit respectively, the MEI value recording unit performs multi-dimensional offline analysis on the application's lifecycle and Page access characteristics, and outputs the analysis result to the online regulation unit for multi-dimensional parameters of the far memory data swap path.

The data swapper of multi-backend disaggregated memory comprises: a memory swap frontend supporting dynamic backend switching, a far memory backend supporting heterogeneous multi-paths, and a lightweight memory switching configuration unit based on the warm start principle, and wherein: the memory swap frontend receives backend switching instructions and connects to different memory swap backends; the far memory backend processes data of RDMA-like far memory backends, CXL-like far memory backends, and disk-like far memory backends; the lightweight memory switching configuration unit implements specific backend switching according to the instruction information of the far memory intelligent multi-backend disaggregated memory management and control module, and analyzes the current resource usage and task deployment status of the current server based on the lightweight memory switching configuration strategy of the warm start principle, and preferentially deploys tasks to the already configured processing units.

The far memory swap path operation data refers to: page fault count, kernel layer running time, and overall running time data of different applications under different far memory access paths and local memory ratio conditions.

The application memory efficiency improvement value refers to: the execution performance of the application (i.e., overall running delay) and the reciprocal of the backend price cost. This step first needs to count the execution time of each application in the processing unit configured with different memory backends and the cost of using the corresponding memory backend, calculate the MEI value corresponding to different applications and different memory backends, and multiple sets of parameter data of multiple tasks and the corresponding MEI values form an MEI data table.

The backend switching includes mutual switching between three types of backends: PCIe-connected CXL-like far memory backends, PCIe-connected remote node DRAM memory backends based on Remote Direct Memory Access (RDMA) network cards, and PCIe-connected disk-like far memory backends.

As shown in FIG. 3, the switching strategy decision of the far memory data swap backend refers to: analyzing the data distribution of known applications, measuring the MEI values of applications with different data distributions on different backends; based on the analysis of the application's MEI value data, sorting different far memory backends according to the MEI value, and adding them to the priority queue for backend selection; comparing the current available remaining resources, placing unavailable backends at the end of the priority queue. Construct a correspondence table between data distribution and backend preferences, and extract memory access characteristics during the application lifecycle to guide data swap configuration of different backends.

The multi-dimensional offline analysis refers to: offline collecting application page information and obtaining application memory access characteristics through calculation and analysis, including data fragmentation ratio characteristic, load-store ratio characteristic, and hot-cold data ratio characteristic. Specifically: in the offline collection phase, when the application is executed in the processing unit, acquiring access information of all memory pages of the application during execution, including page ID, timestamp, page type, and page operation, recording them as a list, then calculating and extracting page access characteristics according to the list, performing feature fusion. Use the ratio of the number of pages with non-contiguous addresses to the total number of pages as the data fragmentation ratio characteristic of the application; use the ratio of page load operations (L) and store operations(S) to the total number of page operations as the load-store ratio characteristic; use the ratio of the number of pages with access times greater than C (C is a customizable threshold) to the total number of pages as the hot-cold data ratio characteristic.

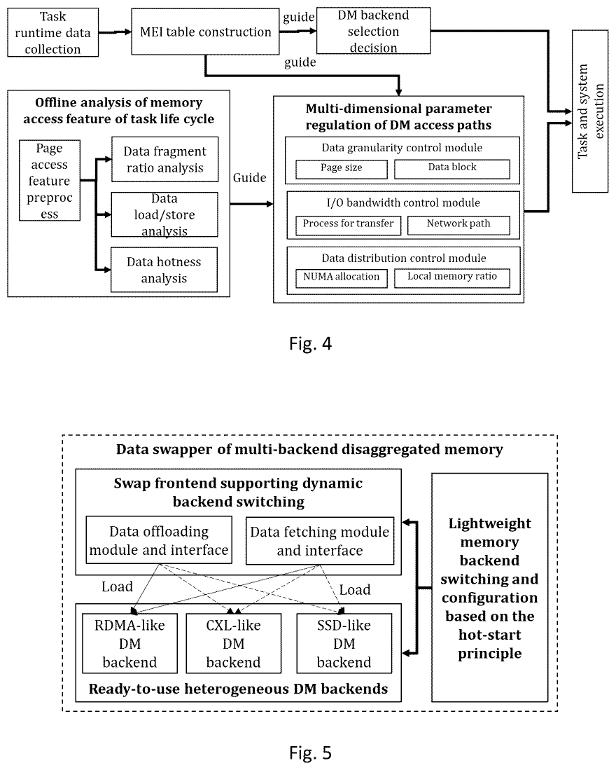

As shown in FIG. 4, the multi-dimensional parameter regulation of the far memory swap path refers to: adjusting parameters of the memory swap path of the application processing unit during the online control phase. The specific adjustment process is: first, establish a mapping relationship between the obtained application memory access characteristics, far memory backend selection, and backend parameter adjustment content, which will guide the adjustment of specific parameters. Among them, the data fragmentation ratio characteristic guides the adjustment of data swap granularity parameters, including parameters such as page size and transmission data block size; the load-store ratio characteristic guides the adjustment of I/O bandwidth parameters, including parameters such as the number of data transmission processes and the number of network paths; the hot-cold data ratio characteristic guides the adjustment of data distribution parameters, including parameters such as the number of NUMA nodes and local memory ratio. After forming a preliminary parameter adjustment plan in this step, under the guidance of the application's Memory Efficiency Improvement (MEI) value, collect the application execution performance and local memory occupation size running on different parameters, then select each parameter corresponding to the optimal MEI value to form the final far memory parameter adjustment plan.

As shown in FIG. 5, the memory swap frontend maps the backend of the far memory swap module to data offloading and data acquisition interfaces of different backends by modifying the data offloading and data acquisition interfaces in the offloading and recycling of memory error pages; by calling the data offloading modules and interfaces corresponding to different far memory backends, the frontend can invoke actual far memory access, thereby calling the ready heterogeneous far memory backends; various far memory backends, including CXL-like far memory backends, remote node DRAM memory backends based on RDMA network cards, and disk-like far memory backends, are established on storage media and data transmission media, and respectively use their hardware drivers, driver call semantics, memory swap semantics, and data transmission methods supported by programming frameworks to define the implementation of memory swap in specific backends, so that the operating system preferentially uses the predefined specific backend to store the offloaded memory page data during data swap. Implement different memory access paths for different operating system kernels, allowing multiple virtual machines to be deployed on one server and operating systems with different far memory backends to be deployed, realizing parallel multi-heterogeneous far memory access paths at the entire machine level. The memory backend module can use hardware drivers to call memory storage media and transmission media, and provide interfaces for upper layers to call memory media. Memory swap semantics use memory media call interfaces to complete data swap between local memory and memory backends.

The RDMA-like far memory backend refers to: using SR-IOV (Single Root I/O Virtualization) technology to create multiple VFs (Virtual Functions) for PCIe-connected RDMA network cards to provide network card virtualization for virtual machines, enabling virtual machines to transmit data with the host through VFs to connect to the RDMA network, and then connect to the far memory space as the far memory space for data swap. The RDMA far memory node pre-allocates a piece of free memory for memory services. When the RDMA network card receives a memory request from the computing node, it uses the DRAM memory of the far memory node to complete data caching.

The CXL-like far memory backend refers to: a PCIe-connected DRAM memory device backend that supports the CXL (Compute Express Link) high-speed interconnection protocol, and allocates swap space on the CXL memory device by calling NUMA control tools.

The disk-like far memory backend refers to: a far memory backend of storage devices connected through PCIe, NVMe, or other I/O interfaces, and sets swap files on the storage space to serve as the far memory space for memory data offloading.

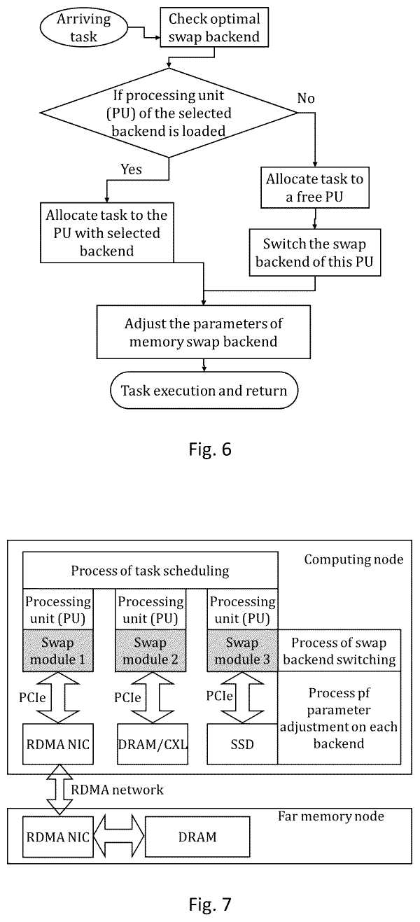

As shown in FIG. 6, the memory switching configuration refers to: when the application has specified the corresponding far memory backend, first query the optimal memory swap backend, then query whether there is an processing unit of the corresponding backend; if it exists, directly allocate the application to the corresponding processing unit; if not, first allocate it to a free processing unit, then switch the backend of the processing unit. Finally, adjust the parameters of the far memory path.

As shown in FIG. 2, the optimized control method of the multi-backend disaggregated memory system based on the above system in this embodiment includes:

Step 1: According to the far memory page swap call record of the task to be processed, calculate the application memory efficiency improvement value based on the far memory swap path operation data, combine with the multi-dimensional offline analysis of the application lifecycle and page access characteristics, generate instruction information for switching the far memory data swap backend through the switching decision of the far memory data swap backend; generate instruction information for multi-dimensional parameter regulation of the far memory swap path through the multi-dimensional parameter regulation unit of the far memory swap path;

Step 2: The data swapper of multi-backend disaggregated memory receives and executes the switch instruction information and parameter regulation instruction information, connects to various ready far memory backends supporting heterogeneous multi-paths, including RDMA-like far memory backends, CXL-like far memory backends, and disk-like far memory backends, and establishes and connects multi-backend far memory paths; Step 3: Analyze the current resource usage and task deployment status of the current [0037] server, and generate lightweight memory switching and configuration instructions based on the warm start principle;

On the far memory access path established in Step 2, according to the instruction information for switching backends generated in Step 1 and the lightweight memory switching and configuration instructions obtained in Step 3, implement specific backend switching for the current task on the three types of memory backends;

Step 4: Run the current task on the disaggregated memory architecture and multi-backend far memory software system, and release resources after the operation ends.

The multi-backend far memory swap includes:
i) The computing node receives the computing task;
ii) The computing node queries the optimal memory swap backend according to the computing task characteristics, current system resource allocation status, and memory backend allocation status;
iii) If there is an processing unit of the corresponding backend, allocate the application to the processing unit for execution;
iv) If there is no processing unit of the corresponding backend, allocate the application to a free processing unit for execution, and then switch the memory backend of the processing unit to the optimal memory swap backend corresponding to the backend;
v) The application is already in the processing unit of its corresponding optimal memory swap backend. Under the control of the parameter adjustment module, the processing unit queries the optimal memory swap parameters of the application under the memory swap backend, and adjusts the memory swap backend parameters according to the parameters;
vi) The application executes under the optimal memory swap backend and optimal memory swap backend path parameters, and returns.
   Allocate different computing tasks to virtual machines corresponding to different memory backends and start execution;
vii) During the execution of the application, the local memory is insufficient, triggering a page fault interrupt, which in turn generates a memory swap request. In the virtual machine, memory swap preferentially passes through the preconfigured data read-write semantics corresponding to the memory backend, and automatically triggers the semantics to complete the read-write of the memory backend;
viii) Multiple applications generate page fault interrupts at the same time, resulting in memory swap. Since virtual machine 1 uses the solid-state disk backend to complete memory swap, virtual machine 2 uses the DRAM backend to complete memory swap, and virtual machine 3 uses the RDMA backend to complete memory swap. The three types of memory swaps are isolated from each other and executed in parallel;
ix) Each application continuously triggers memory swap, completes execution with limited local memory, and the application returns the execution result.

Through specific practical experiments, remote DRAM connected via RDMA is used as the far memory medium, local DRAM connected via PCIe is used as a local memory medium, and local SSD connected via PCIe is used as the local memory swap medium. This embodiment uses two servers equipped with 2 Intel® Xeon® Gold 6148 CPUs with 20 cores each, 256 GB of memory, 2 TB hard disks, and a dual-channel Mellanox ConnectX-5 RDMA network card. One of the servers is used as a computing node, and the other as an RDMA-connected DRAM far memory access node. The computing node contains two types of memory media: solid-state disk and DRAM. The far memory node contains DRAM memory medium. Both the computing node and the far memory node are equipped with RDMA network cards, which are connected through RDMA network cables. In this embodiment, multiple virtual machines are run on the above simplified servers, and each virtual machine is equipped with an independent Linux operating system kernel and the multi-backend disaggregated memory system and its intelligent management method of the present invention, and the corresponding far memory backend is deployed according to task requirements. In this embodiment, three basic virtual machines are pre-built in the computing node: virtual machine 1, virtual machine 2, and virtual machine 3. The hardware used and the virtual machine test system architecture are shown in FIG. 7.

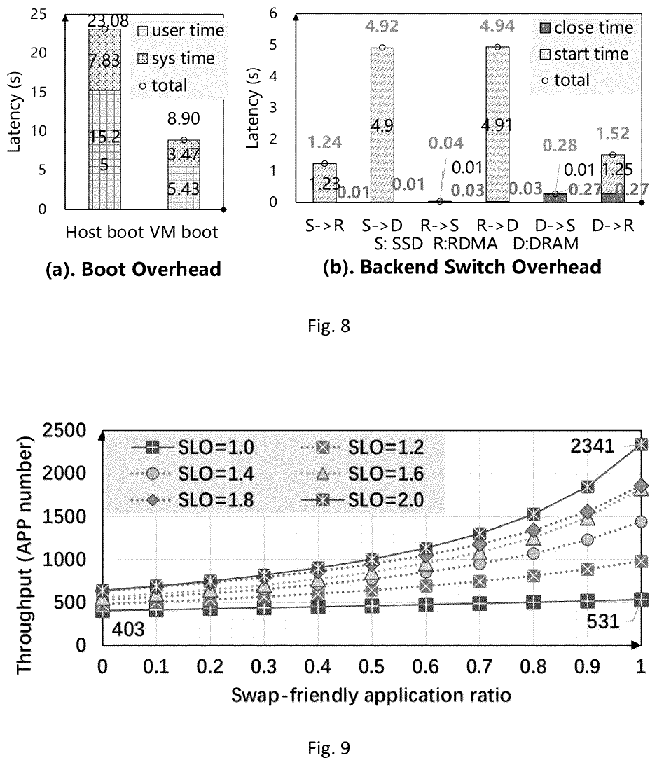

Under the above hardware environment settings, when using three backends: DRAM, SSD, and RDMA, the far memory backend switching time of the system of the present invention and the comparison system is tested, as shown in FIG. 8. This embodiment lists the detailed switching overhead for each switching condition between SSD, DRAM, and RDMA. The results show that the method of the present invention can support multiple far memory backends, and the backend switching time is up to 2.6 times faster than the prior art. Compared with the prior art, the improvement of the backend switching performance index of the method of the present invention mainly comes from the design of the data swapper of multi-backend disaggregated memory in the method of the present invention, which can support kernel modification and fast restart at the virtual machine level.

Under the above hardware environment settings, this embodiment tests the memory swap latency comparison between the system of the present invention and the comparison system under the parameter that the local memory ratio is 0.5-1. As shown in Table 1, it is a comparison diagram of memory swap performance of backend selection and parameter tuning of the multi-backend far memory system of this embodiment.

### Table 1 Results of the Improved Memory Swap Performance Acceleration of the System of the Present Invention

This embodiment measures the following actual computing tasks in data centers, including standard benchmarks linpack, stream, conventional computing applications in spark, graph processing algorithms such as graph traversal, page sorting, subgraph search, and inference tasks of open-source classic artificial intelligence models such as ResNet, Bert, Clip, and Chatglm. This example tests the average memory swap time of each task on different far memory backends under the condition that the local memory size is limited to 0.5 to 1, and compares the results. Under the above hardware environment settings, this embodiment further tests the task throughput comparison between the system of the present invention and the comparison system under the condition that the Service Level Objective (SLO, the allowable latency increase ratio based on the original workload latency) ranges from 1 to 2 and under different task type distributions, as shown in FIG. 9. After calculation, the design of the system of the present invention brings a maximum speedup of 2.16 times on the SSD backend; a maximum speedup of 2.43 times on the DRAM backend; and a maximum speedup of 3.89 times on the RDMA backend. Compared with the prior art, the method of the present invention, through the design of the far memory multi-backend management and control module, can support the activation of higher-performance far memory backends and the configuration of higher-performance far memory parameters.

Compared with the prior art, the system of the present invention allows the design of intelligently switching and configuring far memory backends, supports memory swap with higher performance and higher data bandwidth, and can bring a maximum throughput improvement of 5 times.

The above specific implementations can be partially adjusted in different ways by those skilled in the art without departing from the principles and purposes of the present invention. The protection scope of the present invention is subject to the claims and not limited by the above specific implementations, and all implementation schemes within the scope are bound by the present invention.

What is claimed is:

1. A multi-backend disaggregated memory system, characterized by comprising: an intelligent multi-backend disaggregated memory management and control module and a far memory data swapper of multi-backend disaggregated memory, wherein: the intelligent multi-backend disaggregated memory management and control module analyzes and processes calls that cause page faults and trigger page swapping, to obtain switch instruction information and parameter regulation instruction information; the data swapper of multi-backend disaggregated memory receives the switch instruction information and parameter adjustment instruction information, adjust system parameters configuration, runs applications on the multi-backend disaggregated memory software system, and releases resources after the execution ends.

2. The multi-backend disaggregated memory system according to claim 1, wherein the intelligent multi-backend disaggregated memory management and control module comprises: a Memory Efficiency Improvement (MEI) value recording unit based on far memory swap path operation data, a switching strategy decision unit for far memory data swap backends, a regulation unit for far memory swap path parameters, and a multi-dimensional offline analysis unit for application lifecycle and page access characteristics, wherein: while the MEI value recording unit records the MEI value of the application and transmits it to the switching strategy decision unit and the regulation unit respectively, the MEI value recording unit performs multi-dimensional offline analysis on the application's lifecycle and page access characteristics, and outputs the analysis result to the online regulation unit for multi-dimensional parameters of the far memory data swap path;
and the far memory swap path operation data refers to: page fault count, kernel layer running time, and overall running time data of different applications under different far memory access paths and local memory ratio conditions;
and the application memory efficiency improvement (MEI) value refers to: the execution performance of the application, as know as the reciprocal of the overall running delay and backend price cost, and this step first needs to count the execution time of each application in the processing unit configured with different memory backends and the cost of using the corresponding memory backend, calculate the MEI value corresponding to different applications and different memory backends, and multiple sets of parameter data of multiple tasks and the corresponding MEI values form a MEI data table.

3. The multi-backend disaggregated memory system according to claim 1, wherein the data swapper of multi-backend disaggregated memory comprises: a memory swap frontend supporting dynamic backend switching, a far memory backend supporting heterogeneous multi-paths, and a lightweight memory switching configuration unit based on the warm start principle, and wherein: the memory swap frontend receives backend switching instructions and connects to different memory swap backends; the far memory backend processes data of RDMA-like far memory backends, CXL-like far memory backends, and disk-like far memory backends; the lightweight memory switching configuration unit implements specific backend switching according to the instruction information of the intelligent multi-backend disaggregated memory management and control module, and analyzes the current resource usage and task deployment status of the current server based on the lightweight memory switching configuration strategy of the warm start principle, and preferentially deploys tasks to the already configured processing units;
and the backend switching includes mutual switching between three types of backends: PCIe-connected CXL-like far memory backends, PCIe-connected remote node DRAM memory backends based on Remote Direct Memory Access (RDMA) network cards, and PCIe-connected disk-like far memory backends.

4. The multi-backend disaggregated memory system according to claim 1, wherein the parameter regulation refers to: adjusting parameters of the memory swap path of the application processing unit during the online control phase, specifically comprising:
i) Establishing a mapping relationship between the obtained application memory access characteristics, far memory backend selection, and backend parameter adjustment content to guide the adjustment of specific parameters;
ii) Loading the load-store ratio characteristic to guide I/O bandwidth parameter adjustment; using the hot-cold data ratio characteristic to guide data distribution parameter adjustment to form a preliminary parameter adjustment plan;
iii) Under the guidance of the application's Memory Efficiency Improvement (MEI) value, collecting the application execution performance and local memory occupation size running on different parameters, then selecting each parameter corresponding to the optimal MEI value to form the final far memory parameter adjustment plan.

5. The multi-backend disaggregated memory system according to claim 2, wherein the switching strategy decision of the far memory data swap backend refers to: analyzing the data distribution of known applications, measuring the MEI values of applications with different data distributions on different backends; based on the analysis of the application's MEI value data, sorting different far memory backends according to the MEI value, and adding them to the priority queue for backend selection; comparing the current available remaining resources, placing unavailable backends at the end of the priority queue, constructing a correspondence table between data distribution and backend preferences, and extracting memory access characteristics during the application lifecycle to guide data swap configuration of different backends.

6. The multi-backend disaggregated memory system according to claim 2, wherein the multi-dimensional offline analysis refers to: offline collecting application page information and obtaining application memory access characteristics through calculation and analysis, specifically: in the offline collection phase, when the application is executed in the processing unit, acquiring access information of all memory pages of the application during execution, including page ID, timestamp, page type, and page operation, recording them as a list, then calculating and extracting page access characteristics according to the list, performing feature fusion, and using the ratio of the number of pages with non-contiguous addresses to the total number of pages as the data fragmentation ratio characteristic of the application; using the ratio of page load operations (L) and store operations(S) to the total number of page operations as the load-store ratio characteristic; using the ratio of the number of pages with access times greater than a threshold to the total number of pages as the hot-cold data ratio characteristic.

7. The multi-backend disaggregated memory system according to claim 3, wherein the memory swap frontend maps the backend of the far memory swap module to data offloading and data acquisition interfaces of different backends by modifying the data offloading and data acquisition interfaces in the offloading and recycling of memory error pages; by calling the data offloading modules and interfaces corresponding to different far memory backends, the frontend can invoke different far memory access paths, thereby calling the ready-to-use heterogeneous far memory backends; various far memory backends, including CXL-like far memory backends, remote node DRAM memory backends based on RDMA network cards, and disk-like far memory backends, are established on storage media and data transmission media, and respectively use their hardware drivers, driver call semantics, memory swap semantics, and data transmission methods supported by programming frameworks to define the implementation of memory swap in specific backends, so that the operating system preferentially uses the predefined specific backend to store the offloaded memory page data during data swap, and implement different memory access paths for different operating system kernels, allowing multiple virtual machines to be deployed on one server and operating systems with different far memory backends to be deployed, realizing parallel multi-heterogeneous far memory access paths at the entire machine level, and the said memory backend module can use hardware drivers to call memory storage media and transmission media, and provide interfaces for upper layers to call memory media, and the said memory swap semantics use memory media call interfaces to complete data swap between local memory and memory backends.

8. The multi-backend disaggregated memory system according to claim 3, wherein the RDMA-like far memory backend refers to: using SR-IOV (Single Root I/O Virtualization) technology to create multiple VFs (Virtual Functions) for PCIe-connected RDMA network cards to provide network card virtualization for virtual machines, enabling virtual machines to transmit data with the host through VFs to connect to the RDMA network, and then connect to the far memory space as the far memory space for data swap, and the RDMA far memory node pre-allocates a piece of free memory for memory services, when the RDMA network card receives a memory request from the computing node, it uses the DRAM memory of the far memory node to complete data caching;
and the CXL-like far memory backend refers to: a PCIe-connected DRAM memory device backend that supports the CXL (Compute Express Link) high-speed interconnection protocol, and allocates swap space on the CXL memory device by calling NUMA control tools;
and the disk-like far memory backend refers to: a far memory backend of storage devices connected through PCIe, NVMe, or other I/O interfaces, and sets swap files on the storage space to serve as the far memory space for memory data offloading.

9. The multi-backend disaggregated memory system according to claim 3, wherein the memory switching configuration refers to: when the application has specified the corresponding far memory backend, first query the optimal memory swap backend, then query whether there is a processing unit of the corresponding backend; if it exists, directly allocate the application to the corresponding processing unit; otherwise, first allocate it to a free processing unit, then switch the backend of the processing unit, and finally adjust the parameters of the far memory path.
